(19) United States
(12) Patent Application Publication
(10) Pub. No.: US 2007/0101027 A1
(43) Pub. Date: May 3, 2007

(54) MULTI-INTERFACE STORAGE DEVICE

(75) Inventors: Xiao-Guang Li, Shenzhen (CN); Te-Yao Yeh, Shenzhen (CN); Kuan-Hong Hsieh, Shenzhen (CN); Han-Che Wang, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,827

(22) Filed: Oct. 5, 2006

(30) Foreign Application Priority Data
Oct. 28, 2005 (CN) 200510100802.0

(51) Int. Cl. G06F 13/00

(52) U.S. Cl. 710/32

(57) ABSTRACT

A multi-interface storage device includes: a storage unit for storing data; a first interface and a second interface for electrically connecting to an external data processing system; a data control unit configured for conducting a connection between the first interface and the storage unit, in order that the external data processing system processes the data in the storage unit if the first interface is electrically connected to the external data processing system; the data control unit configured for conducting a connection between the second interface and the storage unit, in order to drive the external data processing system to perform a function of displaying a personal favorite data processing system environment if the second interface is electrically connected to the external data processing system, and a processing unit, connected to an interior control interface; wherein the data control unit is configured for conducting a connection between the interior control interface and the storage unit, in order that the processing unit processes data in the storage unit if the storage device is independently used.

### TECHNICAL FIELD

The present invention relates generally to storage device, and particularly to a multi-interface storage device.

### GENERAL BACKGROUND

With the development of semiconductor storage technology, non-volatile storage devices (hereafter, “storage devices”) are popularly used by all kinds of data processing systems. These data processing systems include notebooks, desktop computers, digital cameras, mobile phones, multimedia players, and so forth. The storage device can be used for storing data, such as operation system data, text files, audio files, video files, etc.

The storage devices are mainly classified in two types: a non-removable storage device that is fastened in the data processing system, such as a hard disk of the notebook or the desktop computer or a storage unit of the media player and a mobile storage device that is connected to the data processing system via an interface of the data processing system, such as a mobile hard disk or a flash memory.

Conventionally, various storage devices only supports one kind of communication interface. For example, the non-removable hard disk only has a parallel interface, the mobile hard disk and the flash memory only has a serial interface. The non-removable storage device may only be used for the data processing system that supports the kind of communication interface of the storage device. If the non-removable storage device is used in the data processing system that supports other kinds of communication interfaces, an adapter or a read/write device is needed. However, it is not very convenient to use the adapter or the read/write device every time the non-removable storage device is used.

To solve such problem, a storage device that supports multi-interfaces is provided. The storage device includes various parallel interfaces and/or various serial interfaces, thus, the storage device can be used in the data processing systems that uses different kinds of communication interfaces. However, regardless of the kinds the communication interface the storage device belongs to, the storage device can only be used for providing the data processing system with data, the storage device does not provide other functions according to the different kinds of the communication interface. In addition, when the storage device is not connected to the data processing system via the communication interfaces, the storage device cannot process data therein, i.e., the storage device cannot be used as a standalone device.

Therefore, what is needed is a multi-interface storage device overcoming the above-described problem.

### SUMMARY

A multi-interface storage device is provided. The storage device includes: a storage unit for storing data; a first interface and a second interface for electrically connecting to an external data processing system; a data control unit configured for conducting a connection between the first interface and the storage unit, in order that the external data processing system processes the data in the storage unit if the first interface is electrically connected to the external data processing system. The data control unit is also configured for conducting a connection between the second interface and the storage unit, in order to drive the external data processing system to perform a function of displaying a personal favorite data processing system environment if the second interface is electrically connected to the external data processing system, and a processing unit connected to an interior control interface. The data control unit is further configured for conducting a connection between the interior control interface and the storage unit, in order that the processing unit processes data in the storage unit if the storage device is independently used.

Other advantages and novel features will be drawn from the following detailed description of the embodiments with reference to the attached drawings, in which:

### BRIEF DESCRIPTION OF DRAWINGS

FIG. 1 is a block diagram of a multi-interface storage device in accordance with a preferred embodiment of the invention;

FIG. 2 is a block diagram of a storage unit of FIG. 1;

FIG. 3 is a flowchart of implementing the storage of FIG. 1;

FIG. 4 is a flowchart of implementing one step of FIG. 3, namely, driving the computer to perform a function of displaying a personal favorite computer environment; and

FIG. 5 is a flowchart of implementing another step of FIG. 3, namely, processing data in the storage unit.

### DETAILED DESCRIPTION

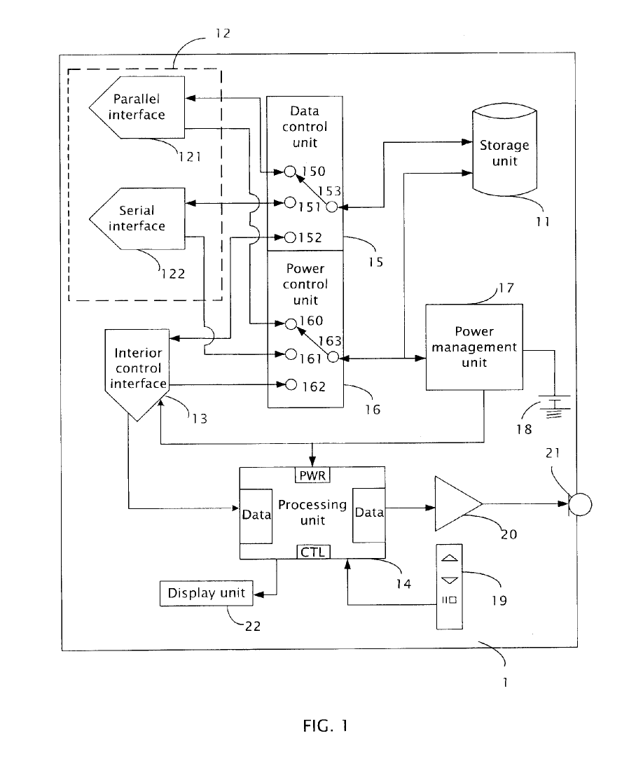

FIG. 1 is a block diagram of a multi-interface storage device (hereafter, “the storage device”) in accordance with a preferred embodiment of the present invention. The storage device 1 may be a removable hard disk. The storage device 1 includes a storage unit 11, an exterior interface group 12, an interior control interface 13, a processing unit 14, and a data control unit 15. The storage unit 11 stores configuration data of the storage device 1, data of an operation system, configuration data of an external data processing system, application programs of the external data processing system (not shown), an audio file list, audio files, a video file list, video files, and so forth. The external data processing system may be a computer, or the like. For simplicity, a personal computer (PC) is adopted as an example. The exterior interface group 12 includes, but not limited to, a parallel interface 121 and a serial interface 122. The parallel interface 121 can be further substituted with a wireless interface. In the preferred embodiment, the parallel interface 121 is adopted as an example. The parallel interface 121 can be an integrated device electronics (IDE) interface. The serial interface 122 can be a universal serial bus (USB) interface. The processing unit 14 can be a central processing unit (CPU) or a microcontroller unit (MCU). The interior control interface 13 is connected to a data interface of the processing unit 14. The data control unit 15 includes a first data terminal 150, a second data terminal 151, a third data terminal 152, and a fourth data terminal 153. The first data terminal 150 is connected to the parallel interface 121; the second data terminal 151 is connected to the serial interface 122; the third data terminal 152 is connected to the interior control interface 13; the fourth data terminal 153 is connected to the storage unit 11, and is further also selectable to connect with either the first data terminal 150, the second data terminal 151, or the third data terminal 152.

When the storage device 1 is used independently, namely a connection between the third data terminal 152 and the fourth data terminal 153 is enabled i.e., the fourth data terminal 153 selects a connection with the third data terminal 152, the interior control interface 13 becomes connected with the storage unit 11, furthermore, the processing unit 14 is able to process data stored in the storage unit 11 via the interior control interface 13. Conversely, when the storage device 1 is connected to the computer via the parallel interface 121, namely a connection between the first data terminal 150 and the fourth data terminal 153 is enabled, i.e., the fourth data terminal 153 selects a connection with the first data terminal 150, the parallel interface 121 becomes connected with the storage unit 11, furthermore, the storage device 1 is adopted as an external hard disk of the computer. Similarly, when the storage device 1 is connected to the computer via the serial interface 122, namely a connection between the second data terminal 151 and the fourth data terminal 153 is enabled, i.e., the fourth data terminal 153 selects a connection with the second data terminal 152, the serial interface 122 becomes connected with the storage unit 11, allowing the storage device 1 to be used for performing a function of displaying a person favorite computer environment (described in more detailed below).

The storage device 1 further includes a power control unit 16, a power management unit 17, and a rechargeable battery 18. The power control unit 16 includes a first power terminal 160, a second power terminal 161, a third power terminal 162, and a fourth power terminal 163. The first power terminal 160 is connected to the parallel interface 121; the second power terminal 161 is connected to the serial interface 122; the third power terminal 162 is connected to the interior control interface 13; the fourth power terminal 163 is connected to the storage unit 11 and the power management unit 17, and is further also connected to the first power terminal 160, the second power terminal 161, or the third power terminal 162.

The power management unit 17 is connected to the rechargeable battery 18 and a power (abbreviated as “PWR” in FIG. 1) port of the processing unit 14. When the storage device 1 is connected to the computer via the parallel interface 121 or the serial interface 122, namely a connection between the first power terminal 160 and the fourth power terminal 163 or between the second power terminal 161 and the fourth power terminal 163 is enabled, i.e., the fourth power terminal 163 selects a connection with the first power terminal 160 or the second power terminal 161. The power control unit 16 draws power supply from the computer to supply power to all components of the storage device 1, and simultaneously, the power management unit 17 charges the rechargeable battery 18. Contrary, when the storage device 1 is used independently, namely a connection between the third power terminal 162 and the fourth power terminal 163 is enabled, i.e., the fourth power terminal 163 selects a connection with the third power terminal 162, the power management unit 17 draws power supply from the rechargeable battery 18 to supply power to other components of the storage device 1.

The storage device 1 further includes a control panel 19, a digital/analog (D/A) converter 20, an output unit 21, and a display unit 22. The control panel 19 and the display unit 22 are connected to a control (abbreviated as “CTL” in FIG. 1) port of the processing unit 14, and the D/A converter 20 is connected to the data port of the processing unit 14. The processing unit 14 obtains audio files stored in the storage unit 11 via the interior control interface 13 and the data control unit 15, and decodes the audio files into digital audio signals. The D/A converter 20 converts the digital audio signals into analog audio signals, whereupon the output unit 21 outputs sounds corresponding to the analog audio signals.

The control panel 19 is used for receiving operational inputs, and generating corresponding control signals to the processing unit 14. The control panel 19 is set a plurality of keys for operational inputs including, but not limited to, a random play key, a default play key, a pause key, a play key, an up key, a down key, a volume adjusting key, a power key, and so on. When the control signal is a random play control signal, the processing unit 14 obtains an audio file list stored in the storage unit 11, generates a random play list according to the audio file list, and plays audio files according to the random play list; when the control signal is a default play control signal from the default play key, the processing unit 14 plays audio files according to a default play list in the storage unit 11. In the preferred embodiment, the default play list is a favorite channel list.

The display unit 22 is used for displaying related information on the audio file played. The information includes contents related to the audio file currently played by the storage device 1.

Additionally, the storage device 1 can perform other functions, such as, play a video file. Correspondingly, the control panel 19, the D/A converter 20, the output unit 21, and the display unit 22 can be substituted for other components.

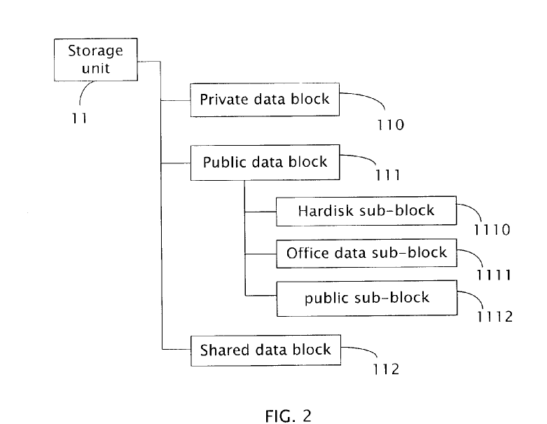

FIG. 2 is block diagram of the storage unit 11 of FIG. 1. The storage unit 11 preferably includes a private data block 110, a public data block 111, and a shared data block 112. The private data block 110 is allocated for storing configuration data of the storage device 1.

The public data block 11 is for storing data accessible by the computer. The public data block 111 further includes a hard disk sub-block 1110, an office data sub-block 1111, and a public sub-block 1112. The hard disk sub-block 1110 is allocated for storing operation system data.

The office data sub-block 1111 is allocated for storing computer configuration data and application programs of the computer. The computer configuration data includes a favorite computer environment configuration data and a general applications configuration data. The favorite computer environment configuration data is for setting a personal favorite computer environment that a user of the storage device 1 is familiar. The general applications can be such as, for example, Microsoft Word, Microsoft Excel, Microsoft Outlook, and so on. The general applications configuration data is for setting general applications according to users' personal preferences.

The application programs are for identifying whether a user operating the storage device 1 is a legal user, determining an operation mode of the computer according to user's choice, controlling a communication between the computer and the storage device 1 according to the operation mode. The operation mode includes a host mode and a client mode. If the operation mode of the computer is in client mode, the computer changes a configuration data pointer of the computer from pointing to the preferred computer configuration data of the storage device 1. Simultaneously, the computer changes a disk pointer of the computer from pointing to the main storage unit (not shown) of the computer to pointing to the public data block 11 of the storage device 1, thereby shielding the main storage unit of the computer from being accessed. Accordingly, the computer directly accesses the public data block 11 to obtain the preferred computer configuration data and “my folders” according to paths pointed by the configuration data pointer and disk pointer of the computer, thus configuring a favorite computer environment according to the favorite computer environment configuration data. Therefore, the user can operate on the computer in a familiar favorite computer environment.

The application programs are further used for operating the storage device in host mode. The user can save files from the computer to the storage device as “my folders” and can also backup files from the storage device to the computer. The application programs are also further used for resetting paths pointer by the configuration data pointer and the disk pointer of the computer when the connection between the computer and the storage device is disabled. The application programs automatically install into the computer once the storage device 1 is connected to the computer via the serial 121 and automatically uninstalls from the computer when the connection between the computer and the storage device 1 is disabled.

The public sub-block 1112 includes at least one predetermined folder, namely “my folders”. “My folders” is for storing important or frequently used data. “My folders” can be such as, for example, my favorite folder, my document folder of a windows operation system, e-mail document folder, and/or some other user-defined folder.

The shared data block 112 is for storing data accessible by both the storage device 1 and the computer. The data includes an audio file list, audio files, a video file list, video files, and so on.

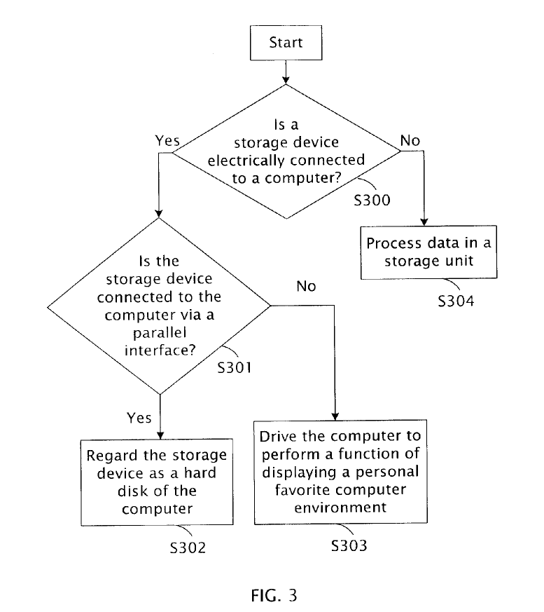

FIG. 3 is a flowchart of implementing the storage device 1 of FIG.1. In step S300, the storage device 1 detects whether it is electrically connected to the computer. If so, the procedure goes to step S301 described below. Otherwise, in step S304, the processing unit 14 processes the data in the storage unit 11.

In step S301, the storage device 1 detects whether it is electrically connected to the computer via the parallel interface 121. If so, in step S302, the storage device 1 can be regarded as the external hard disk of the computer. Otherwise, the storage device 1 is electrically connected to the computer via the serial interface 122, in step S303, the storage device 1 can be used for driving the computer to perform a function of displaying the personal favorite computer environment.

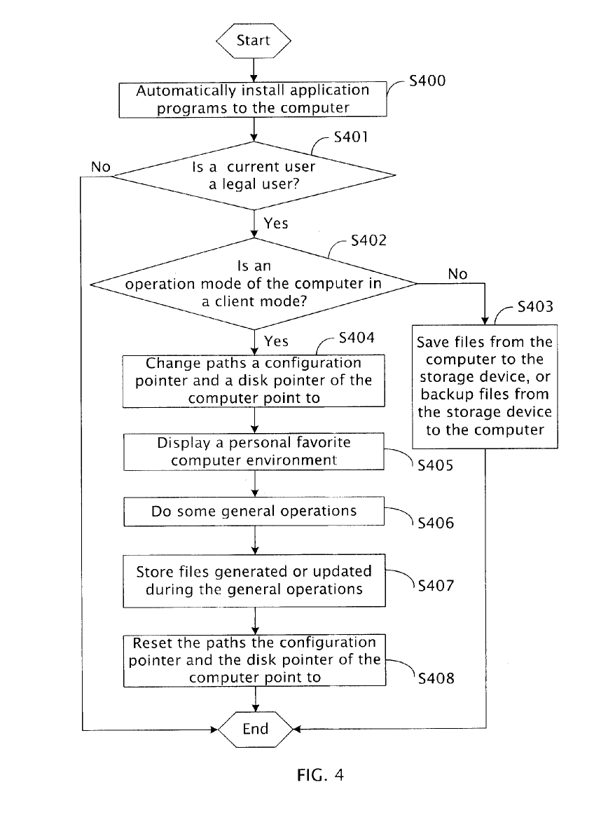

FIG. 4 is a flowchart of implementing step S303 of FIG. 3, namely driving the computer to perform the function of displaying the personal favorite computer environment. In step S400, the application programs in the storage unit 11 automatically install themselves into the computer when the storage device 1 is connected to the computer. In step S401, the data control unit 15 determines whether the user operating on the storage device 1 is a legal user of the storage device 1 according to a user name and a password input. If the user operating on the storage device 1 is an illegal user, the procedure is finished. Otherwise, in step S402, the data control unit 15 determines whether the operation mode of the computer is in a client mode according to the user's selection. If the operation mode of the computer is in a host mode, in step S403, the user can save files from the computer into the storage device 1 as “my folder”, and can also backup files from the storage device 1 to the computer.

If the operation mode of the computer is in the client mode, in step S404, the computer changes a configuration pointer thereof from pointing to the computer configuration data of the computer to pointing to the preferred computer configuration data of the storage device 1, and, simultaneously, changes a disk pointer of the computer from pointing to main storage unit (not shown) of the computer to pointing to the public data block 11 of the storage device 1, thereby shielding the main storage unit of the computer from being accessed. In step S405, the computer directly accesses the public data block 11 to obtain the computer configuration data and “my folders” according to a path pointer by the configuration pointer and the disk pointer of the computer, and thus to display the familiar favorite computer environment for the user according to the favorite computer environment configuration data. In step S406, the user can execute general operations such as reading, writing, or modifying on the computer, if necessary. In step S407, files generated or updated by general operations are stored to the public data block 111. In step S408, when the connection between the computer and the storage device 1 is disabled, the computer changes the configuration pointer and the disk pointer of the computer to point to the path of computer configuration data and the main storage unit of the computer respectively.

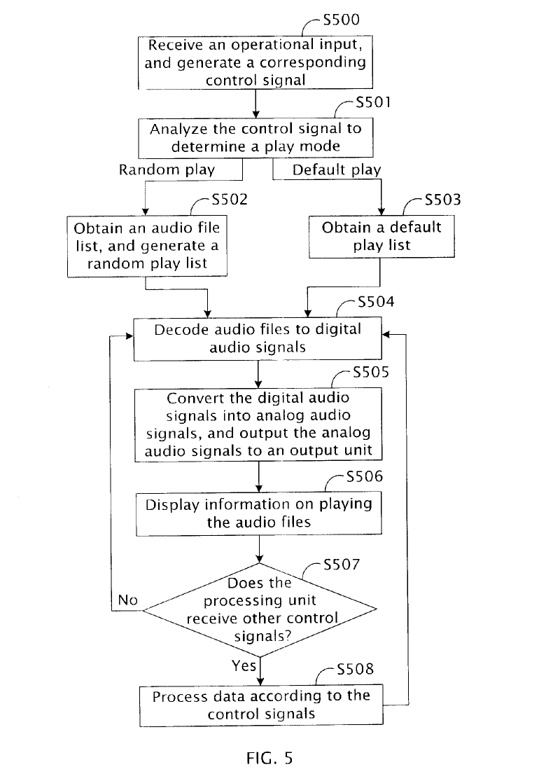

FIG. 5 is a flowchart of implementing step S304 of FIG. 3, namely processing the data in the storage unit 11. In the preferred embodiment, it is adopted as an example that the processing unit 14 plays the audio files in the storage unit 11. In step S500, the control panel 19 receives an operational input, and generates a corresponding control signal. The control signal is a play mode selection signal. In step S501, the processing unit 14 analyzes the control signal to determine a play mode. In the S502, if the control signal is a random play control signal, the processing unit 14 obtains an audio file list in the storage unit 11, and generates a random play list. In step S504, the processing unit 14 decodes the audio files included in the random play list to digital audio signals, and outputs the digital audio signals to the D/A converter 20. In step S505, the D/A converter 20 converts the digital audio signals into analog audio signals, and outputs the analog audio signals to the output unit 21. In step S506, the display unit 22 displays related information on playing the audio files. In step S507, the processing unit 14 detects whether to receive other control signals from the control panel 19. If the processing unit 14 receives the other control signals, in step S508, the processing unit 14 processes the data in the storage unit 11 according the control signals. Otherwise, the procedure returns to step S504 described above.

When the control signal is a default play control signal, in step S503, the processing unit 14 obtains a default play list, whereupon the procedure goes to step S504 described above.

Although the present invention has been specifically described on the basis of the preferred embodiment including the preferred method, the invention is not to construed as being limited thereto. Various changes or modifications may be made to the embodiment including the method without departing from the scope and spirit of the invention.

What is claimed is:

1. A multi-interface storage device comprising:
a storage unit for storing data;
a first interface and a second interface for electrically connecting to an external data processing system;
a data control unit configured for conducting a connection between the first interface and the storage unit, in order that the external data processing system processes the data in the storage unit if the first interface is electrically connected to the external data processing system;
the data control unit configured for conducting a connection between the second interface and the storage unit, in order to drive the external data processing system to perform a function of displaying a personal favorite data processing system environment if the second interface is electrically connected to the external data processing system, and
a processing unit, connected to an interior control interface; wherein the data control unit is configured for conducting a connection between the interior control interface and the storage unit, in order that the processing unit processes data in the storage unit if the storage device is independently used.

2. The multi-interface storage device as described in claim 1, wherein the first interface is a parallel interface, and the second interface is selective from one of a serial interface and a wireless interface.

3. The multi-interface storage device as described in claim 1, further comprising: a power control unit for conducting a connection between the first interface/second interface and the storage unit, and a connection between the first interface/second interface and a power management unit, obtaining power from the external data processing system and supplying the power to the storage device, if the first interface/second interface is electrically connected to the external data processing system.

4. The multi-interface storage device as described in claim 3, further comprising:
a rechargeable battery for supplying power to the storage device if the storage device is independently used; and
a power management unit, connected to the rechargeable battery, for controlling the rechargeable battery to supply power if the storage device is independently used, or charges for the rechargeable battery via the external data processing system if the storage device is electrically connected to the external data processing system.

5. The multi-interface storage device as described in claim 4, wherein the power control unit further conducts a connection between the interior control interface and the storage unit, and a connection between the interior control interface and the power management unit in order that the rechargeable battery supplies power to the storage device if the storage device is independently used.

6. The multi-interface storage device as described in claim 1, wherein the data in the storage unit comprises a media play list, a default play list, and media files.

7. The multi-interface storage device as described in claim 6, further comprising a control panel for receiving an operational input, and generating a corresponding control signal to the processing unit to process the data in the storage unit, wherein the control panel comprises a random play key for receiving random play operation and a default play key for receiving default play operation.

8. The multi-interface storage device as described in claim 7, wherein the processing unit generates a random play list according to the media play list, decodes the media files in the random play list, and outputs corresponding digital audio signals, in response to the control signal from the random play key; and the processing unit decodes the media files in the default play list and outputs corresponding digital audio signals in response to the control signal from the default play key.

9. The multi-interface storage device as described in claim 8, further comprising a digital/analog (D/A) converter for converting the digital audio signals into analog audio signals, and outputting the analog audio signals to an output unit.

10. The multi-interface storage device as described in claim 9, further comprising a display unit for displaying information on the audio signals played.

11. The multi-interface storage device as described in claim 1, wherein the storage unit comprises:
a private data block for storing configuration data of the storage device;
a public data block for storing data processing system configuration data, at least one predetermined folder, and an application program which are accessible by the external data processing system; and
a shared data block for storing data that are accessible by both the processing unit and the data processing system.

12. The multi-interface storage device as described in claim 11, wherein:
the data control unit changes a configuration pointer of the external data processing system from pointing to data processing system configuration data of the external data processing system to pointing to the data processing system configuration data of the storage device, simultaneously changes a disk pointer of the external data processing system from pointing to a main storage unit of the external data processing system to pointing to the public data block of the storage device respectively, and accesses the public data block to obtain the data processing system configuration data and the at least one predetermined folder, when the storage device is electrically connected to the external data processing system via a serial interface; and
the data control unit changes the configuration data pointer from pointing to the data processing system configuration data of the storage device to pointing to the data processing system configuration data of the external data processing system, and simultaneously resets the disk pointer of the external data processing system from the public data block of the storage device to a main storage unit of the external data processing system, when the connection between the storage device and the external data processing system is disabled.

13. The multi-interface storage device as described in claim 12, wherein the data processing system configuration data comprises a favorite data processing system environment configuration data and a general applications configuration data.

14. The multi-interface storage device as described in claim 1, wherein the storage device is a removable storage device.
